(19) United States
(12) Patent Application Publication
(10) Pub. No.: US 2019/0264609 A1
(43) Pub. Date: Aug. 29, 2019

(54) METHOD OF CLEANING AN INTERNAL COMBUSTION ENGINE AND SYSTEM THEREFOR

(71) Applicant: HYDRIVE APS, Gedved (DK)

(72) Inventor: Uffe Lauge Jensen, Gedved (DK)

(21) Appl. No.: 16/348,716

(22) PCT Filed: Oct. 30, 2017
(86) PCT No.: PCT/EP2017/077747

§ 371 Date: May 9, 2019

(30) Foreign Application Priority Data
Nov. 18, 2016 (DK) PA 2016 00715
Aug. 23, 2017 (DK) PA 2017 00461

(51) Int. Cl. F02B 77/04; F02M 25/12; F02B 43/10; C25B 1/04; C25B 15/02

(52) U.S. Cl. CPC F02B 77/04; F02M 25/12; F02B 2043/106; C25B 1/04; C25B 15/02; F02B 43/10

(57) ABSTRACT

The present invention relates to the use of a gas delivery system for cleaning an internal combustion engine. The gas delivery system is adapted to deliver hydrogen gas, and optionally oxygen gas, into the air intake duct of the internal combustion engine when the engine operates idle. The hydrogen gas is delivered at an amount of at least 15 liters per minute, and the hydrogen gas, and optionally the oxygen gas, is continuously produced by electrolysis of water.

### TECHNICAL FIELD OF THE INVENTION

The present invention relates to internal combustion engines, and more specifically to cleaning of internal combustion engines mounted on a vehicle driven by one or more internal combustion engines.

### BACKGROUND OF THE INVENTION

Most vehicles such as cars, motorcycles, trains, boats, and portable machinery, such as electric generators, utilize internal combustion engines.

Generally, these engines use fossil fuel to operate.

In the internal combustion engine, combustion of a fuel occurs with an oxidizer (air) in a combustion chamber. The expansion of the high temperature and high-pressure gases produced by the combustion process exert forces to mechanical components of the engine transforming chemical energy into useful mechanical energy. Incomplete oxidation during the combustion, or improper combustion, may increase the emissions.

Emissions carry harmful substances, such as carbon monoxides, nitrogen oxides, and other greenhouse gases, such as carbon dioxide that can adversely affect health and the environment. To control the emissions, users and manufacturers of internal combustion engines must comply with stringent regulations and emissions control standards.

For economic and environmental reasons, technologies on fuel and engine have been developed to produce internal combustion engines with improved fuel efficiency and reduced emissions. For example, unleaded fuels are used for reducing carbon deposits in the engine, and fuel additives are used for increasing performance and fuel efficiency of the engine.

However, the effects of carbon build-up are still present in almost all vehicles, and the use of some fuel additives may further increase carbon deposits in the engine. Excessive build-up of carbon deposits in the engine will reduce engine performance and create significant drivability issues.

It is therefore desirable to provide a system, which can remove the already built-up carbon deposits in an internal combustion engine.

### SUMMARY OF THE INVENTION

The inventor of the present invention has provided an external system configured to remove the built-up of carbon deposits in an internal combustion engine. In the present context, the term “external system” refers to a system that is only connected to the internal combustion engine during the cleaning operation as opposed to devices that are connected to the internal combustion engine during normal use. Surprisingly, it was found that administering large quantities of hydrogen gas into the internal combustion engine when the engine operates idle, and during a period of 10-90 minutes was enough to remove the carbon deposits. Without being bound by any specific theory, it is speculated that the hydrogen reacts, in an exothermic reaction, with a) oxygen being co-administered and/or b) oxygen from the air intake duct of the internal combustion engine to form water vapor. This exothermic reaction, releases the carbon deposits from the inner walls of the engine system, thereby decreasing the NOX emission from the system.

A first aspect of the present invention relates to the use of a gas delivery system for cleaning an internal combustion engine; wherein the gas delivery system is adapted to deliver hydrogen gas, and optionally oxygen gas, into the air intake duct of the internal combustion engine when the engine operates idle; wherein the hydrogen gas is delivered at an amount of at least 15 liters per minute for a period of 10-90 minutes; wherein the hydrogen gas, and optionally the oxygen gas, is continuously produced by electrolysis of water.

A second aspect relates to a gas delivery system adapted for cleaning an internal combustion engine, the system comprising:
means configured for producing hydrogen gas by performing electrolysis on water, and configured for delivering hydrogen in an amount of at least 15 liters per minute for a period of 10-90 minutes; and
means adapted for transferring the produced hydrogen, and optional oxygen, to the air intake duct of an internal combustion engine when the engine operates idle.

A third aspect relates to the use of a gas delivery system configured to deliver hydrogen gas, and optionally oxygen gas, for cleaning an internal combustion engine; wherein an internal combustion engine with an engine displacement of 1-20 liters is treated with 900-2,500 liters of hydrogen gas per hour; wherein the hydrogen, and optionally the oxygen gas, is delivered into the air intake duct of the internal combustion engine; wherein the hydrogen gas, and optionally the oxygen gas, is continuously produced by means capable of performing electrolysis on water, and wherein a direct current electrical supply is configured to deliver direct current pulses of 200-1000 Hertz to the means capable of performing electrolysis on water.

A fourth aspect relates to a gas delivery system adapted for cleaning an internal combustion engine, the gas delivery system comprising:
means capable of performing electrolysis on water; and
means adapted for transferring the produced hydrogen to an internal combustion engine;
a direct current electrical supply configured to deliver direct current pulses of 200-1000 Hertz to the means capable of performing electrolysis on water; and
a controller adapted for receiving user input about the engine displacement of an internal combustion engine to be treated, the engine displacement being within the range of 1-20 liters, and in response to said input, instruct the means capable of performing electrolysis on water to produce a specific amount of hydrogen per hour within the range of 900-2,500 liters of hydrogen gas per hour.

### DETAILED DESCRIPTION OF THE INVENTION

A first aspect of the present invention relates to the use of a gas delivery system for cleaning an internal combustion engine; wherein the gas delivery system is adapted to deliver hydrogen gas, and optionally oxygen gas, into the air intake duct of the internal combustion engine when the engine operates idle; wherein the hydrogen gas is delivered at an amount of at least 15 liters per minute for a period of 10-90 minutes; wherein the hydrogen gas, and optionally the oxygen gas, is continuously produced by electrolysis of water.

In one or more embodiments, the hydrogen gas and the oxygen gas is continuously produced in doses by electrolysis of water.

When a pulsed voltage is imposed on the terminals of an electrochemical cell a corresponding pulsed current through the cell is produced. In the present context, the pulsed current and pulsed voltage are generally interchangeable. A peak current is turned on for a period of time called the on-time, followed by a zero current for a period of time called the off-time. The sum of on-time and off-time is known as the period of the pulse and the inverse of the period is known as the frequency of the pulse. The percent on-time in a pulse is defined as the duty-cycle of the pulse. The pulsed voltage results in an increased production rate of hydrogen compared to normal DC electrolysis.

In one or more embodiments, the hydrogen gas and, optionally, the oxygen gas is continuously produced by means configured to perform electrolysis on water, and wherein a direct current electrical supply is configured to deliver direct current pulses of 200-1000 Hertz to the means configured to perform electrolysis on water, such as within the range of 250-950 Hertz, e.g. within the range of 300-900 Hertz, such as within the range of 350-850 Hertz, e.g. within the range of 400-800 Hertz, such as within the range of 450-750 Hertz, e.g. within the range of 500-700 Hertz, such as within the range of 550-650 Hertz.

In one or more embodiments, the hydrogen gas is delivered at an amount of at least 15 liters per minute for a period of 10-90 minutes, such as at least 20 liters hydrogen gas per minute for a period of 10-90 minutes, e.g.

at least 25 liters hydrogen gas per minute for a period of 10-90 minutes, such as at least 30 liters hydrogen gas per minute for a period of 10-90 minutes, e.g. at least 35 liters hydrogen gas per minute for a period of 10-90 minutes, such as at least 40 liters hydrogen gas per minute for a period of 10-90 minutes, e.g. at least 45 liters hydrogen gas per minute for a period of 10-90 minutes, such as at least 50 liters hydrogen gas per minute for a period of 10-90 minutes, e.g. at least 55 liters hydrogen gas per minute for a period of 10-90 minutes, such as at least 60 liters hydrogen gas per minute for a period of 10-90 minutes, e.g. at least 65 liters hydrogen gas per minute for a period of 10-90 minutes, such as at least 70 liters hydrogen gas per minute for a period of 10-90 minutes, e.g. at least 75 liters hydrogen gas per minute for a period of 10-90 minutes, such as at least 80 liters hydrogen gas per minute for a period of 10-90 minutes, e.g. at least 85 liters hydrogen gas per minute for a period of 10-90 minutes, such as at least 90 liters hydrogen gas per minute for a period of 10-90 minutes, e.g. at least 95 liters hydrogen gas per minute for a period of 10-90 minutes, such as at least 100 liters hydrogen gas per minute for a period of 10-90 minutes, e.g. at least 105 liters hydrogen gas per minute for a period of 10-90 minutes, such as at least 110 liters hydrogen gas per minute for a period of 10-90 minutes, e.g. at least 115 liters hydrogen gas per minute for a period of 10-90 minutes, such as at least 120 liters hydrogen gas per minute for a period of 10-90 minutes, e.g. at least 125 liters hydrogen gas per minute for a period of 10-90 minutes, such as at least 130 liters hydrogen gas per minute for a period of 10-90 minutes, e.g. at least 135 liters hydrogen gas per minute for a period of 10-90 minutes, such as at least 140 liters hydrogen gas per minute for a period of 10-90 minutes, e.g. at least 145 liters hydrogen gas per minute for a period of 10-90 minutes, such as at least 150 liters hydrogen gas per minute for a period of 10-90 minutes, e.g. at least 155 liters hydrogen gas per minute for a period of 10-90 minutes, such as at least 160 liters hydrogen gas per minute for a period of 10-90 minutes, e.g. at least 165 liters hydrogen gas per minute for a period of 10-90 minutes, such as at least 170 liters hydrogen gas per minute for a period of 10-90 minutes, e.g. at least 175 liters hydrogen gas per minute for a period of 10-90 minutes, such as at least 180 liters hydrogen gas per minute for a period of 10-90 minutes, e.g. at least 185 liters hydrogen gas per minute for a period of 10-90 minutes, such as at least 190 liters hydrogen gas per minute for a period of 10-90 minutes, e.g. at least 195 liters hydrogen gas per minute for a period of 10-90 minutes. Preferably, the internal combustion engine is treated for 10-90 minutes, such as for 15-85 minutes, e.g. for 20-80 minutes, such as for 25-75 minutes, e.g. for 30-70 minutes, such as for 35-65 minutes, e.g. for 40-60 minutes, and even more preferred for 10-35 minutes, such as for 15-30 minutes, e.g. for 20-25 minutes. The inventor has found that a period of 15-30 minutes is ideal.

In one or more embodiments, the hydrogen gas is delivered at an amount of 15-200 liters per minute for a period of 10-90 minutes, such as within the range of 20-195 liters hydrogen gas per minute for a period of 10-90 minutes, e.g. 25-190 liters hydrogen gas per minute for a period of 10-90 minutes, such as within the range of 30-185 liters hydrogen gas per minute for a period of 10-90 minutes, e.g. 35-170 liters hydrogen gas per minute for a period of 10-90 minutes, such as within the range of 40-165 liters hydrogen gas per minute for a period of 10-90 minutes, e.g. 45-160 liters hydrogen gas per minute for a period of 10-90 minutes, such as within the range of 50-155 liters hydrogen gas per minute for a period of 10-90 minutes, e.g. 55-150 liters hydrogen gas per minute for a period of 10-90 minutes, such as within the range of 60-145 liters hydrogen gas per minute for a period of 10-90 minutes, e.g. 65-140 liters hydrogen gas per minute for a period of 10-90 minutes, such as within the range of 70-135 liters hydrogen gas per minute for a period of 10-90 minutes, e.g. 75-130 liters hydrogen gas per minute for a period of 10-90 minutes, such as within the range of 80-125 liters hydrogen gas per minute for a period of 10-90 minutes, e.g. 85-120 liters hydrogen gas per minute for a period of 10-90 minutes, such as within the range of 90-115 liters hydrogen gas per minute for a period of 10-90 minutes, e.g. 95-110 liters hydrogen gas per minute for a period of 10-90 minutes.

In one or more embodiments, the internal combustion engine suitable for the treatment has an engine displacement of 1-30 liters, such as an engine displacement of 2-29 liters, e.g. an engine displacement of 3-28 liters, such as an engine displacement of 4-27 liters, e.g. an engine displacement of 5-26 liters, such as an engine displacement of 6-25 liters, e.g. an engine displacement of 7-24 liters, such as an engine displacement of 8-23 liters, e.g. an engine displacement of 9-22 liters, such as an engine displacement of 10-21 liters, e.g. an engine displacement of 11-20 liters, such as an engine displacement of 12-19 liters, e.g. an engine displacement of 13-18 liters, such as an engine displacement of 14-17 liters, e.g. an engine displacement of 15-16 liters.

In one or more embodiments, an internal combustion engine with an engine displacement of 1-3 liters is treated with 15-30 liters hydrogen gas per minute for a period of 10-90 minutes.

In one or more embodiments, an internal combustion engine with an engine displacement of 4-6 liters is treated with 30-50 liters hydrogen gas per minute for a period of 10-90 minutes.

In one or more embodiments, an internal combustion engine with an engine displacement of 7-9 liters is treated with 45-70 liters hydrogen gas per minute for a period of 10-90 minutes.

In one or more embodiments, an internal combustion engine with an engine displacement of 10-12 liters is treated with 60-90 liters hydrogen gas per minute for a period of 10-90 minutes.

In one or more embodiments, an internal combustion engine with an engine displacement of 13-15 liters is treated with 75-110 liters hydrogen gas per minute for a period of 10-90 minutes.

In one or more embodiments, an internal combustion engine with an engine displacement of 16-18 liters is treated with 90-130 liters hydrogen gas per minute for a period of 10-90 minutes.

In one or more embodiments, an internal combustion engine with an engine displacement of 19-21 liters is treated with 105-150 liters hydrogen gas per minute for a period of 10-90 minutes.

In one or more embodiments, an internal combustion engine with an engine displacement of 22-24 liters is treated with 120-170 liters hydrogen gas per minute for a period of 10-90 minutes.

In one or more embodiments, an internal combustion engine with an engine displacement of 25-27 liters is treated with 135-190 liters hydrogen gas per minute for a period of 10-90 minutes.

In one or more embodiments, an internal combustion engine with an engine displacement of 28-30 liters is treated with 150-210 liters hydrogen gas per minute for a period of 10-90 minutes.

In one or more embodiments, the hydrogen and oxygen gas is delivered into the air intake duct of the internal combustion engine.

In one or more embodiments, the hydrogen and oxygen gas is mixed with the air entering the air intake duct of the internal combustion engine prior to reaching the internal combustion engine.

A second aspect relates to a gas delivery system adapted for cleaning an internal combustion engine, the gas delivery system comprising:
means configured for producing hydrogen gas by performing electrolysis on water, and configured for delivering hydrogen in an amount of at least 15 liters per minute for a period of 10-90 minutes; and
means adapted for transferring the produced hydrogen, and optional oxygen, to the internal combustion engine when the engine operates idle.

A third aspect relates to the use of a gas delivery system configured to deliver hydrogen gas, and optionally oxygen gas, for cleaning an internal combustion engine; wherein an internal combustion engine with an engine displacement of 1-20 liters is treated with 900-2,500 liters of hydrogen gas per hour; wherein the hydrogen, and optionally the oxygen gas, is delivered into the air intake duct of the internal combustion engine; wherein the hydrogen gas, and optionally the oxygen gas, is continuously produced by means capable of performing electrolysis on water, and wherein a direct current electrical supply is configured to deliver direct current pulses of 200-1000 Hertz to the means capable of performing electrolysis on water.

A fourth aspect relates to a gas delivery system adapted for cleaning an internal combustion engine, the gas delivery system comprising:
means capable of performing electrolysis on water; and
means adapted for transferring the produced hydrogen to an internal combustion engine;
a direct current electrical supply configured to deliver direct current pulses of 200-1000 Hertz to the means capable of performing electrolysis on water; and
a controller adapted for receiving user input about the engine displacement of an internal combustion engine to be treated, the engine displacement being within the range of 1-20 liters, and in response to said input, instruct the means capable of performing electrolysis on water to produce a specific amount of hydrogen per hour within the range of 900-2,500 liters of hydrogen gas per hour.

In one or more embodiments, an internal combustion engine with an engine displacement of 10-20 liters is treated with 900-2,500 liters of hydrogen gas per hour, such as within the range of 900-2,400 liters of hydrogen gas per hour, e.g. within the range of 900-2,300 liters of hydrogen gas per hour, such as within the range of 900-2,200 liters of hydrogen gas per hour, e.g.

within the range of 950-2,100 liters of hydrogen gas per hour, such as within the range of 1,000-2,000 liters of hydrogen gas per hour, e.g. within the range of 1,100-1,900 liters of hydrogen gas per hour, such as within the range of 1,200-1,800 liters of hydrogen gas per hour, e.g. within the range of 1,300-1,700 liters of hydrogen gas per hour, such as within the range of 1,400-1,600 liters of hydrogen gas per hour, e.g. within the range of 1,450-1,550 liters of hydrogen gas per hour.

In one or more embodiments, the hydrogen, and optionally the oxygen gas, is mixed with the air entering the air intake duct of the internal combustion engine prior to reaching the internal combustion engine.

A fifth aspect relates to a gas delivery system adapted for cleaning an internal combustion engine, the gas delivery system comprising:
means configured for producing hydrogen gas by performing electrolysis on water, and configured for delivering hydrogen in an amount of at least 15 liters per minute for a period of 10-90 minutes; and
means adapted for transferring the produced hydrogen, and optional oxygen, to the air intake duct of an internal combustion engine when the engine operates idle.

In one or more embodiments, the means configured to deliver hydrogen in an amount of at least 15 liters per minute comprises means configured to perform pulsed direct current electrolysis on water; and wherein the gas delivery system further comprises a controller adapted for receiving user input about the engine displacement of an internal combustion engine to be cleaned, and in response to said input, instruct the means configured to perform electrolysis on water to produce a specific amount of hydrogen per minute; wherein the specific amount is at least 15 liters per minute.

In one or more embodiments, the gas delivery system further comprises a heating unit configured to heat the water for the electrolysis process to a temperature within the range of 20-40 degrees Celsius, such as within the range of 25-35 degrees Celsius. The inventor has found that this temperature range is optimal for obtaining large quantities of hydrogen gas.

In one or more embodiments, the gas delivery system further comprises means configured for sensing if the internal combustion engine stops during the cleaning operation, and configured to automatically shut down the means configured to perform electrolysis on water if the internal combustion engine stops during the cleaning operation. This configuration is a security measure to avoid the production of large quantities of hydrogen gas that may accidentally ignite in the room where the internal combustion engine is treated.

In one or more embodiments, the means configured for sensing if the internal combustion engine stops during the cleaning operation comprises a vibration sensor adapted for being mounted to the engine block and/or to the bodywork of the vehicle that comprises the internal combustion engine. The means may we wired or wireless.

In one or more embodiments, the gas delivery system further comprises a controller adapted for receiving user input about the engine displacement of an internal combustion engine to be treated, and in response to said input, instruct the means configured to perform electrolysis on water to produce a specific amount of hydrogen per hour.

It should be noted that embodiments and features described in the context of one of the aspects of the present invention also apply to the other aspects of the invention.

The present invention is not limited by a specific type of means configured to perform electrolysis on water. However, an example of a means configured to perform electrolysis on water could comprise:

an electrolytic cell, for generation of a water electrolytic gas, including

an electrolyte inlet (e.g. formed in a bottom wall),

an outlet (e.g. formed in a top wall) adapted to extract a mixture of an electrolyte and a generated gas,

an anode plate (e.g. internally arranged near the bottom wall),

a cathode plate (e.g. internally arranged near a top wall), and

an electrolyte spinning and passing portion, for spinning and passing an alkali electrolyte in a direction leading from the anode plate to the cathode plate;

a separation cell, for an electrolyte/water electrolytic gas, in which gas-liquid separation is performed for the mixture that has been extracted from the outlet in the upper end of the electrolytic cell and the mixture that includes the electrolyte and a water electrolytic gas, and as a result, gas components comprising the water electrolytic gas are separated from the electrolyte, so that only the gas components are externally extracted, while an electrolyte component is retained, internally; and

an electrolyte circulation unit, for circulating, toward the electrolytic cell, the electrolyte that has been retained in the separation cell. The electrolyte spinning and passing portion, which is located between the anode plate and the cathode plate in the electrolytic cell, may comprise a predetermined number of metal plates (e.g. 5 steel plates) with a plurality of electrolyte passage openings. The metal plates are arranged by sequentially displacing the electrolyte passage openings at a predetermined angle, so that the electrolyte is passed through the metal plates, while spinning is being performed.

The metal plates are not electrically connected to the anode plate or the cathode plate, or to another portion or each other. Instead, the metal plates are securely supported by an insulating member.

Potassium hydroxide (KOH), which is an alkali electrolyte, and water are introduced into the electrolytic cell, and a direct-current voltage is applied between the anode plate, arranged inside, near the bottom of the electrolytic cell, and the cathode plate, arranged near the top thereof, in accordance with the polarities of these electrodes. As a result, the potassium hydroxide (KOH) electrolyte and water are forced upwards in the electrolytic cell, while being spun between the anode plate, located near the bottom, and the cathode, located near the top. During this process, electrolysis progresses, while the reaction for the generation of hydrogen gas (and oxygen gas) continues to develop in the electrolyte solution.

When electrons collide with a metal plate (that serves as a member of the electrolyte spinning and passing portion), arranged between the anode plate and the cathode plate, oxonium ions (H₃O⁺) are generated by the collisions and are moved to the cathode side, and anions (OH⁻) are also so generated and are moved to the anode side. When multiple metal plates have been so arranged, a large quantity of water electrolytic gas can be generated in the electrolytic cell. Thereafter, the mixture of the electrolyte and an increased amount of the thus generated hydrogen gas is extracted via the outlet formed in the upper end of the electrolytic cell. As would be appreciated by a person skilled in the art, the size of the anode and cathode plates, the magnitude of the electric current (voltage, amperes) used, and the flow and temperature of the electrolyte solution are decisive for the amount of generated hydrogen gas (and oxygen gas).

The thus extracted mixture of the electrolyte and the hydrogen gas is passed through a connecting pipe to a separation cell, in which gas-liquid separation is thereafter performed to separate the hydrogen gas from the electrolyte. Hence, only the hydrogen gas (and oxygen gas) is extracted via the lead-out pipe, and is transferred to the internal combustion motor. The residual electrolyte is recirculated through the electrolytic cell to continue the above described reaction process.

As an example, an internal combustion engine with an engine displacement of 3 liters is treated with 25 liters hydrogen gas per minute for a period of 20-30 minutes. The means configured to deliver hydrogen gas comprises means configured to perform pulsed direct current electrolysis on water (potassium hydroxide solution, 25% KOH w/w). The electrolysis is conducted with a pulsed direct current of 36 volts (60 amperes), and at a frequency of 400 Hz.

As another example, an internal combustion engine with an engine displacement of 20 liters is treated with 110 liters hydrogen gas per minute for a period of 20-30 minutes. The means configured to deliver hydrogen gas comprises means configured to perform pulsed direct current electrolysis on water (potassium hydroxide solution, 25% KOH w/w). The electrolysis is conducted with a pulsed direct current of 77 volts (260 amperes), and at a frequency of 400 Hz.

1.-10. (canceled)

11. A method for cleaning an internal combustion engine comprising the steps of:
a) coupling means configured to produce hydrogen gas by performing electrolysis on water to the air intake duct of an internal combustion engine such that hydrogen gas may be transferred thereto;
b) configuring an internal combustion engine to operate in idle mode;
c) configuring the means configured to produce hydrogen gas by performing electrolysis on water to continuously produce a predefined amount of hydrogen gas depending on the size of said internal combustion engine; wherein said amount is:
i) 15-30 liters hydrogen gas per minute for a period of 10-90 minutes when the internal combustion engine has an engine displacement of 1-3 liters;
ii) 30-50 liters hydrogen gas per minute for a period of 10-90 minutes when the internal combustion engine has an engine displacement of 4-6 liters;
iii) 45-70 liters hydrogen gas per minute for a period of 10-90 minutes when the internal combustion engine has an engine displacement of 7-9 liters;
iv) 60-90 liters hydrogen gas per minute for a period of 10-90 minutes when the internal combustion engine has an engine displacement of 10-12 liters;
v) 75-110 liters hydrogen gas per minute for a period of 10-90 minutes when the internal combustion engine has an engine displacement of 13-15 liters;
vi) 90-130 liters hydrogen gas per minute for a period of 10-90 minutes when the internal combustion engine has an engine displacement of 16-18 liters;
vii) 105-150 liters hydrogen gas per minute for a period of 10-90 minutes when the internal combustion engine has an engine displacement of 19-21 liters;
viii) 120-170 liters hydrogen gas per minute for a period of 10-90 minutes when the internal combustion engine has an engine displacement of 22-24 liters;
ix) 135-190 liters hydrogen gas per minute for a period of 10-90 minutes when the internal combustion engine has an engine displacement of 25-27 liters; and
x) 150-210 liters hydrogen gas per minute for a period of 10-90 minutes when the internal combustion engine has an engine displacement of 28-30 liters.

12. The method according to claim 11, wherein the hydrogen gas is delivered to the internal combustion engine for 10-50 minutes.

13. The method according to claim 11, wherein the gas delivery is automatically stopped if the internal combustion engine stops during the cleaning operation.

14. The method according to claim 11, wherein the hydrogen gas is mixed with the air entering the air intake duct of the internal combustion engine prior to reaching the internal combustion engine.

15. The method according to claim 11, wherein the water for the electrolysis process is heated to a temperature within the range of 20-40 degrees Celsius.

16. A gas delivery system adapted for cleaning an internal combustion engine operating in idle mode, the system comprising:
means configured to produce hydrogen gas by performing electrolysis on water, and configured for delivering a specific amount of hydrogen gas in response to user input about the internal combustion engine's engine displacement; and
means adapted for transferring the produced hydrogen, and optional oxygen, to the air intake duct of an internal combustion engine when the engine operates idle;
a controller adapted for receiving user input about the engine displacement of an internal combustion engine to be cleaned, and in response to said input, instruct the means configured to perform electrolysis on water to produce a specific amount of hydrogen per minute, and wherein said amount is:
i) 15-30 liters hydrogen gas per minute for a period of 10-90 minutes when the internal combustion engine has an engine displacement of 1-3 liters;
ii) 30-50 liters hydrogen gas per minute for a period of 10-90 minutes when the internal combustion engine has an engine displacement of 4-6 liters;
iii) 45-70 liters hydrogen gas per minute for a period of 10-90 minutes when the internal combustion engine has an engine displacement of 7-9 liters;
iv) 60-90 liters hydrogen gas per minute for a period of 10-90 minutes when the internal combustion engine has an engine displacement of 10-12 liters;
v) 75-110 liters hydrogen gas per minute for a period of 10-90 minutes when the internal combustion engine has an engine displacement of 13-15 liters;
vi) 90-130 liters hydrogen gas per minute for a period of 10-90 minutes when the internal combustion engine has an engine displacement of 16-18 liters;
vii) 105-150 liters hydrogen gas per minute for a period of 10-90 minutes when the internal combustion engine has an engine displacement of 19-21 liters;
viii) 120-170 liters hydrogen gas per minute for a period of 10-90 minutes when the internal combustion engine has an engine displacement of 22-24 liters;
ix) 135-190 liters hydrogen gas per minute for a period of 10-90 minutes when the internal combustion engine has an engine displacement of 25-27 liters; and
x) 150-210 liters hydrogen gas per minute for a period of 10-90 minutes when the internal combustion engine has an engine displacement of 28-30 liters.

17. The gas delivery system according to claim 16, wherein the means configured to produce hydrogen gas by performing electrolysis on water comprises means configured to perform pulsed direct current electrolysis on water.

18. The gas delivery system according to claim 16, further comprising a heating unit configured to heat the water for the electrolysis process to a temperature within the range of 20-40 degrees Celsius.

19. The gas delivery system according to claim 16, further comprising means configured for sensing if the internal combustion engine stops during the cleaning operation and configured to automatically shut down the means configured to perform electrolysis on water if the internal combustion engine stops during the cleaning operation.

20. The gas delivery system according to claim 16, further comprising means configured for sensing if the internal combustion engine stops during the cleaning operation, and configured to automatically shut down the means configured to perform electrolysis on water if the internal combustion engine stops during the cleaning operation, and wherein the means configured for sensing if the internal combustion engine stops during the cleaning operation comprises a vibration sensor adapted for being mounted to the engine block and/or to the bodywork of the vehicle that comprises the internal combustion engine.
